(19) United States
(12) Patent Application Publication
(10) Pub. No.: US 2008/0246722 A1
(43) Pub. Date: Oct. 9, 2008

(54) DISPLAY APPARATUS

(75) Inventors: Ryoichi Tsuzaki, Kanagawa (JP); Kazunori Yamaguchi, Kanagawa (JP); Tsutomu Harada, Kanagawa (JP); Mitsuru Tateuchi, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/061,131

(22) Filed: Apr. 2, 2008

(30) Foreign Application Priority Data
Apr. 6, 2007 (JP) 2007-100884

(51) Int. Cl. G09G 3/36

(52) U.S. Cl. 345/104

(57) ABSTRACT

A display apparatus includes an input/output unit adapted to display an image and sense light incident thereon from the outside. The input/output unit is capable of accepting simultaneous inputting to a plurality of points on a display screen of the input/output unit. The display screen is covered with a transparent or translucent protective sheet.

### CROSS REFERENCES TO RELATED APPLICATIONS

The present invention contains subject matter related to Japanese Patent Application JP 2007-100884 filed in the Japanese Patent Office on Apr. 6, 2007, the entire contents of which are incorporated herein by reference.

### BACKGROUND OF THE INVENTION

1. Field of the Invention

The present invention relates to a display apparatus, and more particularly, to a display apparatus having an input/output unit adapted to display an image and sense light incident thereon from the outside.

2. Description of the Related Art

One technique for outputting information associated with a plurality of points on a panel is to dispose an optical sensor in a liquid crystal display apparatus and detect light input from the outside by the optical sensor (see, for example, Japanese Unexamined Patent Application Publication No. 2004-127272). Hereinafter, such an apparatus will be referred to as an input/output panel.

In an input/output panel, light incident thereon may be detected in various manners. In one technique, a user operates a pen or the like having an external light source (such as a LED (Light Emitting Diode)) disposed thereon, and light emitted from the light source is detected. In another technique, a user performs an input operation using his/her finger or a pen having no light source, and light emitted from a liquid crystal display apparatus (more specifically, light emitted from a backlight lamp and transmitted via a display panel of the liquid crystal display apparatus) and reflected to the inside of the liquid crystal display apparatus from a pen or a user's finger located in the vicinity of the display screen of the liquid crystal display apparatus is detected by a optical sensor.

In the case of a touch panel of an electrostatic type or a pressure sensitive type, when a point on the touch panel is touched, information associated with the touched point (for example, information indicating coordinates of the point) is output. However, point information is limited to only a single point at a time.

When a user touches two points on the touch panel at the same time, the touch panel selects one of the two points, for example, depending on which point is pressed with a higher pressure or depending on which point was started to be pressed earlier, and the touch panel outputs only point information associated with the selected point.

In view of the above, it is desirable to provide an input/output panel adapted to output point information associated with a plurality of points. Such a type of input/output panel will find various applications.

### SUMMARY OF THE INVENTION

The display screen of the input/output panel functions both to display images thereon and to sense light incident thereon from the outside. Therefore, if the surface of the display screen is damaged or dirtied with dust, fingermarks, or the like, not only visibility but also the light sensitivity is degraded.

In view of the above, it is desirable to provide an input/output panel having high resistance to damage and dirt.

According to an embodiment of the present invention, there is provided a display apparatus including an input/output unit adapted to display an image and sense light incident thereon from the outside, the input/output unit being adapted to accept simultaneous inputting to a plurality of points on a display screen of the input/output unit, the display screen being covered with a transparent or translucent protective sheet.

The surface of the protective sheet may be partially recessed or raised in a particular shape.

The surface of the protective sheet may be partially recessed or raised in a particular shape corresponding to a user interface displayed on the display screen.

The protective sheet may be colored.

In the display apparatus, as described above, the input/output unit is adapted to display an image and sense light incident thereon from the outside, the input/output unit is capable of accepting simultaneous inputting to a plurality of points on a display screen of the input/output unit, and the display screen is covered with a transparent or translucent protective sheet.

In this configuration of the display apparatus, the display screen adapted to display an image and sense light incident from the outside is protected from damage and dirt and thus degradation in the visibility and light sensitivity of the display apparatus is prevented.

### BRIEF DESCRIPTION OF THE DRAWINGS

FIG. 1 is a block diagram illustrating a display system according to an embodiment of the present invention;

FIG. 2 is a schematic diagram illustrating an example of a structure of an input/output display;

FIG. 3 is a schematic diagram illustrating an example of a multiplayer structure of a main part of an input/output display;

FIG. 4 is a diagram illustrating drivers disposed at various locations to control an operation of an input/output display;

FIG. 5 is a diagram illustrating an example of a circuit configuration of a pixel of an input/output display;

FIG. 6 is a flow chart illustrating a displaying/sensing operation performed by a display system;

FIG. 7 is a diagram illustrating software configured to perform a displaying/sensing operation;

FIG. 8 is a diagram illustrating targets existing in a t-th frame at time t;

FIG. 9 is a diagram illustrating input spots existing in a (t+1)th frame in a state in which merging is not yet performed;

FIG. 10 is a diagram in which a t-th frame and a (t+1)th frame are illustrated in a superimposed manner;

FIG. 11 is a diagram illustrating an example of a sensed light image;

FIG. 12 is a flow chart illustrating details of a merging process;

FIG. 13 is a diagram illustrating an example of a manner in which target information and event information are output by a generator;

FIG. 14 is a diagram illustrating another example of a manner in which target information and event information are output by a generator;

FIG. 15 is a diagram illustrating an example of an external structure of an input/output display;

FIG. 16 is a diagram illustrating another example of an external structure of an input/output display;

FIG. 17 is a diagram illustrating another example of an external structure of an input/output display;

FIG. 18 is a block diagram illustrating a display system according to another embodiment of the present invention;

FIG. 19 is a block diagram illustrating a display system according to another embodiment of the present invention;

FIG. 20 is a plan view illustrating an input/output panel configured in the form of a module according to an embodiment of the present invention;

FIG. 21 is a perspective view of a television set having an input/output panel according to an embodiment of the present invention;

FIG. 22 is a perspective view of a digital camera having an input/output panel according to an embodiment of the present invention;

FIG. 23 is a perspective view of a personal computer having an input/output panel according to an embodiment of the present invention;

FIG. 24 is a perspective view of a portable terminal apparatus having an input/output panel according to an embodiment of the present invention; and

FIG. 25 is a perspective view of a video camera having an input/output panel according to an embodiment of the present invention.

### DESCRIPTION OF THE PREFERRED EMBODIMENTS

Before describing an embodiment of the present invention, the correspondence between the features of the invention and the specific elements disclosed in embodiments of the present invention is discussed below. This description is intended to assure that embodiments supporting the invention are described in this specification. Thus, even if an element in the following embodiments is not described as relating to a certain feature of the present invention, that does not necessarily mean that the element does not relate to that feature of the claims. Conversely, even if an element is described herein as relating to a certain feature of the invention, that does not necessarily mean that the element does not relate to other features of the invention.

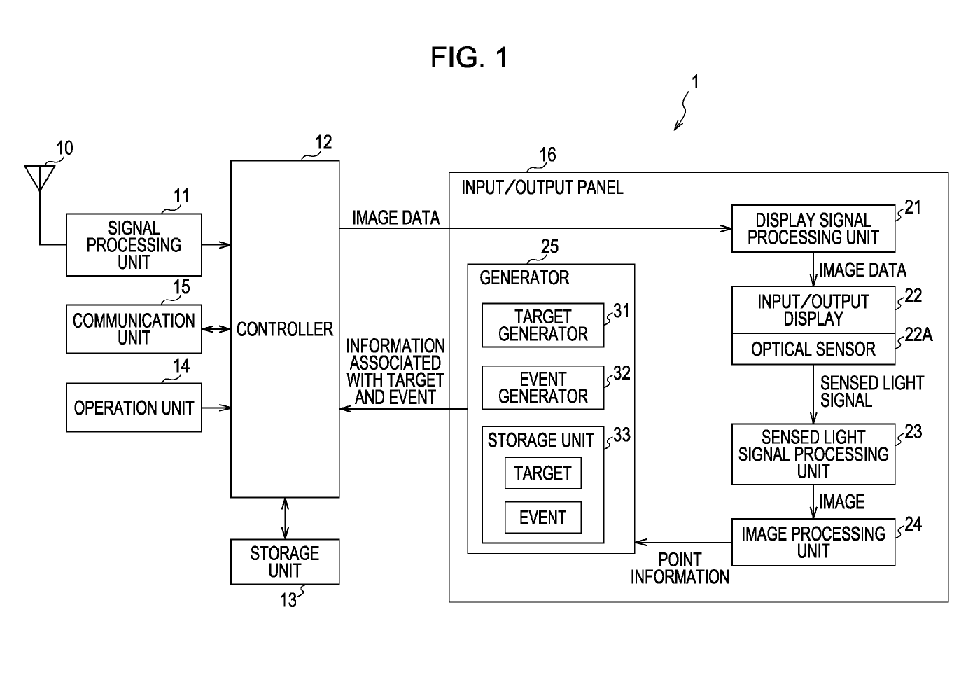

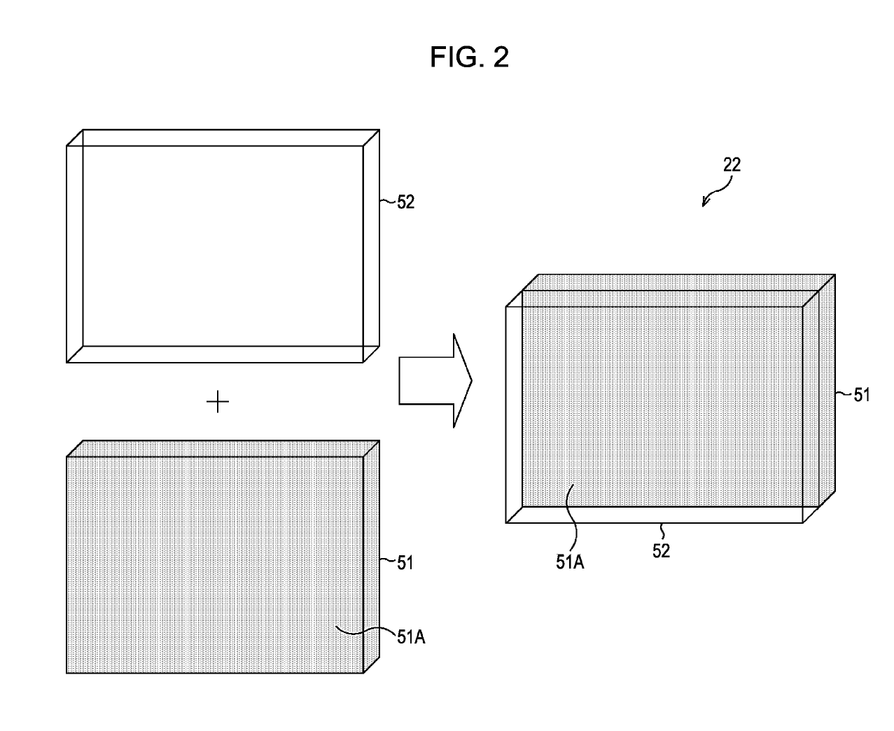

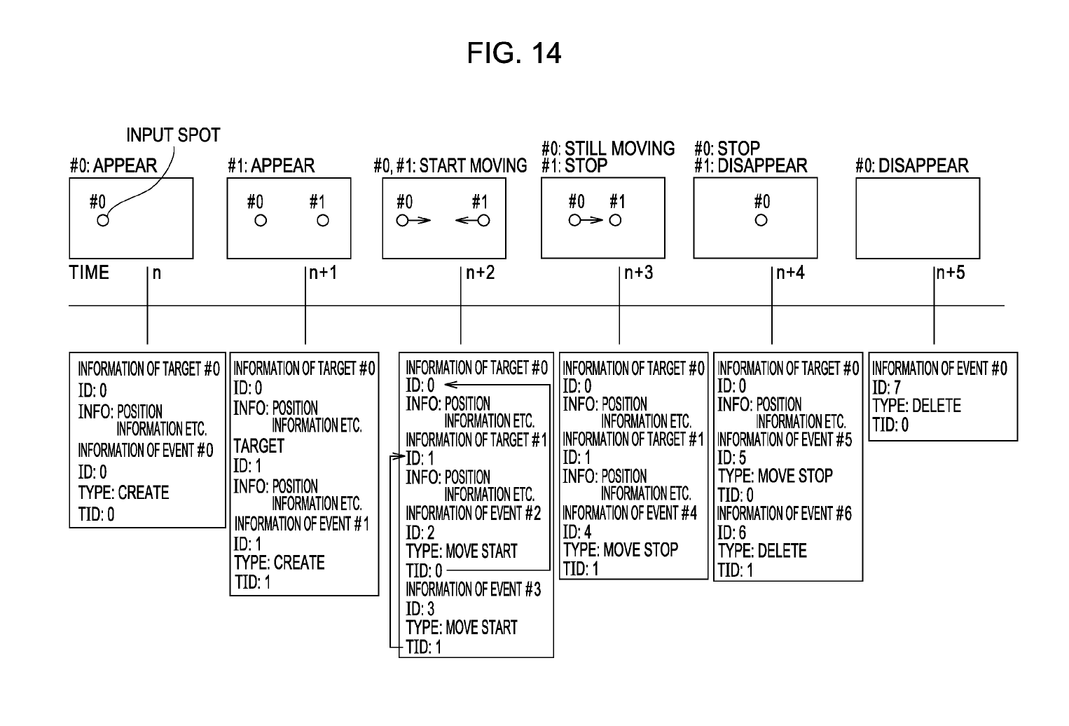

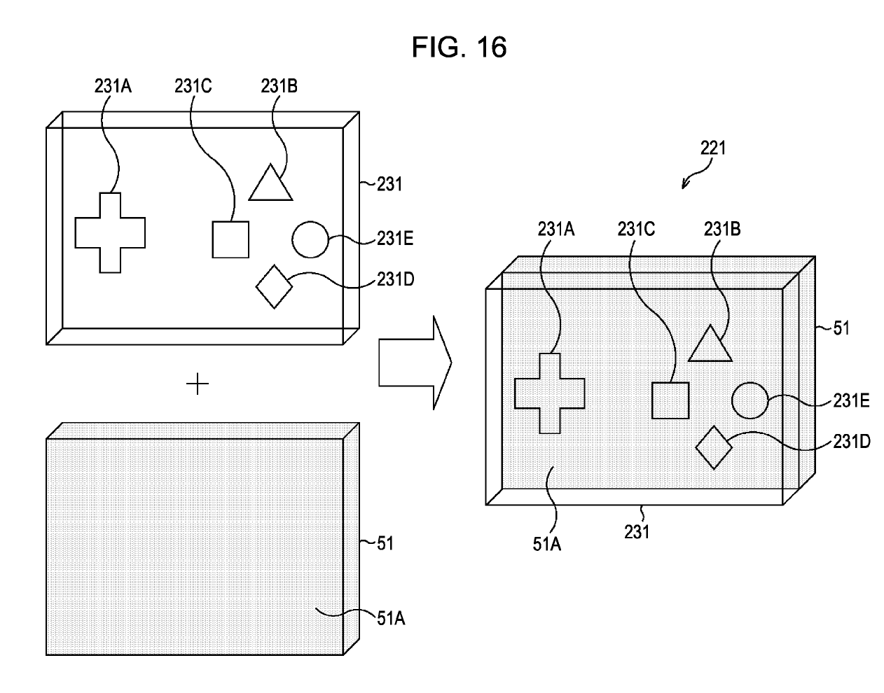

According to an embodiment of the present invention, there is provided a display apparatus including an input/output unit (for example, an input/output display 22 shown in FIG. 1) adapted to display an image and sense light incident thereon from the outside. The input/output unit is adapted to accept simultaneous inputting to a plurality of points on a display screen (for example, a display screen 51A shown in FIG. 2) of the input/output unit, and the display screen is covered with a transparent or translucent protective sheet (for example, a protective sheet 52 shown in FIG. 2, a protective sheet 211 shown in FIG. 14, a protective sheet 231 shown in FIG. 16, or a protective sheet 261 shown in FIG. 16).

The present invention is described in further detail below with reference to preferred embodiments in conjunction with the accompanying drawings.

FIG. 1 is a block diagram illustrating a display system according to an embodiment of the present invention.

In FIG. 1, the display system 1 is, for example, a portable telephone device or a television (TV) receiver.

The display system 1 includes an antenna 10, a signal processing unit 11, a controller 12, a storage unit 13, an operation unit 14, a communication unit 15, and an input/output panel 16.

The signal processing unit 11 demodulates and/or decodes a television radio wave such as a terrestrial television radio wave or satellite television radio wave received by the antenna 10. Image data and audio data obtained as a result of the demodulating/decoding are supplied to the controller 12.

The controller 12 performs various processes in accordance with an operation signal, which is supplied from the operation unit 14 depending on an operation performed by a user. Intermediate data generated in the processes is stored in the storage unit 13. The controller 12 supplies image data received from the signal processing unit 11 to the input/output panel 16. Furthermore, the controller 12 produces image data in accordance with target/event information supplied from the input/output panel 16 and supplies the resultant image data to the input/output display 22 thereby to change the mode in which the image is displayed on the input/output display 22, as required.

The storage unit 13 is realized by, for example, a RAM (Random Access Memory). The storage unit 13 is used by the controller 12 to temporarily store data.

The operation unit 14 is realized by, for example, a ten keypad, a keyboard, or the like. When the operation unit 14 is operated by a user, the operation unit 14 generates an operation signal corresponding to the operation performed by the user and supplies the generated operation signal to the controller 12.

The communication unit 15 is adapted to communicate with a radio station (not shown) using a radio wave.

The input/output panel 16 displays an image on the input/output display 22 in accordance with image data supplied from the controller 12. The input/output panel 16 also produces target/event information by performing a recognition process and a merging process on information associated with one or more points detected from the sensed light signal output from the input/output display 22, and the input/output panel 16 supplies the resultant target/event information to the controller 12.

The input/output panel 16 includes a display signal processing unit 21, an input/output display 22, a sensed light signal processing unit 23, an image processing unit 24, and a generator 25.

The display signal processing unit 21 processes image data supplied from the controller 12 thereby to create image data to be supplied to the input/output display 22. The resultant image data is supplied to the input/output display 22.

The input/output display 22 is configured to display an image and detect light input from the outside. More specifically, the input/output display 22 displays an image on a display screen thereof in accordance with image data supplied from the display signal processing unit 21. The input/output display 22 includes a plurality of optical sensors 22A distributed over the entire surface of the display screen whereby the input/output display 22 detects light incident from the outside, generates a sensed light signal corresponding to the intensity of incident light, and supplies the resultant sensed light signal to the sensed light signal processing unit 23.

The sensed light signal processing unit 23 processes the sensed light signal supplied from the input/output display 22 so as to create an image whose brightness is different between an area where a user's finger is in contact with or close proximity to the display screen of the input/output display 22 and an area where nothing is in contact with or close proximity to the display screen, on a frame-by-frame basis. The resultant image is supplied to the image processing unit 24.

The image processing unit 24 performs image processing, including binarization, noise removal, and labeling, on each frame of image supplied from the sensed light signal processing unit 23 thereby to detect an input spot where a user's finger or a pen is brought in contact with or close proximity to the display screen of the input/output display 22. The image processing unit 24 obtains point information associated with the input spot (more specifically, information indicating the coordinates of a representative point of the input spot on the display screen) and supplies the point information to the generator 25.

The generator 25 generates information associated with a target (hereinafter referred to simply as target information) by performing a merging process (described later) on the point information of the input spot supplied from the image processing unit 24. In accordance with the target information, the generator 25 generates event information indicating a change in the status of the target by performing a recognition process (described later). Note that information associated with some events is generated in the merging process.

The generator 25 includes a target generator 31, an event generator 32, and a storage unit 33, and is configured to generate target information and event information for each frame and supply the generated target information and the event information to the controller 12.

Inputting information to the input/output display 22 can be performed by bringing a user's finger or the like into contact with or close proximity to the display screen. A target is defined as a sequence of inputs to the input/output display 22. More specifically, for example, after a finger is brought into contact with or close proximity to the display screen of the input/output display 22, if the finger is moved a particular distance while maintaining the finger in contact with or close proximity to the display screen, and if the finger is moved away from the display screen, a target is formed by the sequence of inputs on the display screen of the input/output display 22.

An event indicates a change in the status of a target. An event is generated, for example, when the position of a target changes, a new target appears (or is generated), or a target disappears (or is deleted).

The target generator 31 of the generator 25 merges point information of an input spot of each frame supplied from the image processing unit 24 over a plurality of frames, and generates target information indicating a sequence of input spots to which inputting has been given from the outside, in accordance with relationships in terms of temporal and/or spatial locations of the input spots. The resultant generated target information is supplied to the storage unit 33.

For example, when point information of a (t+1)th frame at time t+1 is given as point information associated with an input spot to the target generator 31 from the image processing unit 24, the target generator 31 compares the point information associated with the input spot in the (t+1)th frame with target information associated with a t-th frame at time t that is immediately previous in time to the (t+1)th frame.

When a certain target in the t-th frame is taken as a target of interest, the target generator 31 detects an input spot located spatially closest to the target of interest from the (t+1)th frame, regards the detected input spot as part of the target of interest given by the sequence of inputs, and merges the detected input spot into the target of interest.

In a case where no input spot located physically close to the target of interest is detected in the (t+1)th frame, the target generator 31 determines that the sequence of inputs is completed, and the target generator 31 deletes the target of interest.

In a case where an input spot remaining without being merged into any target is detected in the (t+1)th frame, the target generator 31 determines that a new sequence of inputs has been started, and the target generator 31 creates a new target. The target generator 31 supplies information associated with the resultant target and information associated with the newly created target, as target information of the (t+1)th frame, to the storage unit 33.

The event generator 32 produces event information indicating a change in the status of each target, as required, in accordance with the target information, and the event generator 32 supplies the event information to the storage unit 33. More specifically, for example, the event generator 32 analyzes the target information of the t-th frame, the target information of the (t+1)th frame, and, if necessary, target information of one or more frames previous to the t-th frame stored in the storage unit 33, to detect an event, i.e., a change in the status of a target. The event generator 32 produces event information indicating the content of the detected event and supplies the produced event information, as event information of the (t+1)th frame, to the storage unit 33.

The event generator 32 reads the target information and the event information of the (t+1)th frame from the storage unit 33 and supplies them to the controller 12.

If the storage unit 33 receives the target information from the target generator 31 and the event information from the event generator 32, the storage unit 33 stores them.

FIG. 2 schematically illustrates an example of an external structure of the input/output display 22. The input/output display 22 includes a main body 51 and a display screen 51A adapted to display an image and sense light incident thereon from the outside. The display screen 51A is covered with a protective sheet 52 for protecting the display screen 51A from being damaged or dirtied.

The protective sheet 52 may be formed of a transparent material in the shape of a thin plate. It is desirable that the transparent material used herein be light in weight, resistant to damage and dirt, high in durability, and high in processability. For example, an acryl resin may be used as the material for this purpose. The protective sheet 52 may be connected to the display screen 51A using screws or the like such that the display screen 51A is covered with the protective sheet 52, or may be bonded to the display screen 51A using an adhesive such as a cellophane film such that the display screen 51A is covered with the protective sheet 52.

More specifically, for example, the protective sheet 52 may be formed in a multilayer structure whose one surface (back surface) in contact with the display screen 51A is made of a transparent, adhesive, and light material such as a silicone resin and whose opposite surface (external surface) is made of a material such as PET (polyethylene terephthalate) that is transparent, light in weight, resistant to damage and dirt, and high in durability. The protective sheet 52 is bonded to the display screen 51A such that the display screen 51A is covered with the protective sheet 52.

Note that the protective sheet 52 is made of a transparent material so that the input/output display 22 has high visibility and high sensitivity to light. Even when a finger of a user or a pen is frequently brought into contact with the display screen 51A of the input/output display 22, the protective sheet 52 protects the surface of the display screen 51A from being damaged or dirtied thereby protecting the display screen 51A from being degraded in visibility or light sensitivity.

Strictly speaking, a finger of a user or a pen is brought into contact with the display screen 51A not directly but via the protective sheet 52. However, in the following explanation, for ease of understanding, a simple expression “brought into contact with the display screen 51A” will be used.

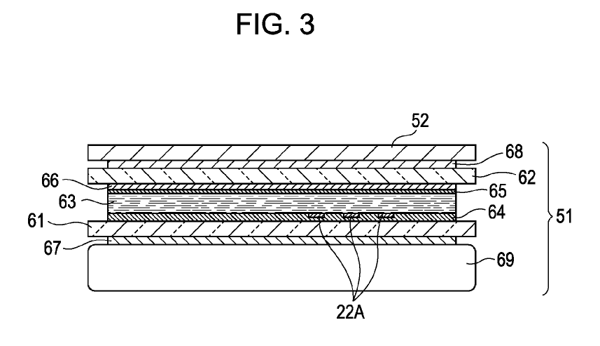

FIG. 3 schematically illustrates an example of a multiplayer structure of the main body 51 of the input/output display 22.

The main body 51 of the input/output display 22 is formed such that two transparent substrates made of glass or the like, i.e., a TFT (Thin Film Transistor) substrate 61 and an opposite electrode substrate 62, are disposed in parallel with each other, and a liquid crystal layer 63 is formed between these two transparent substrates by disposing a liquid crystal such as a twisted nematic (TN) liquid crystal in a gap between the two transparent substrates in a sealed manner.

On a surface, facing the liquid crystal layer 63, of the TFT substrate 61, there is formed an electrode layer 64 including thin film transistors (TFTs) serving as switching elements, pixel electrodes, and insulating layers adapted to provide insulation among the thin film transistors and pixel electrodes. On a surface, facing the liquid crystal layer 63, of the opposite electrode substrate 62, there are formed an opposite electrode 65 and a color filter 66. By these parts, i.e., the TFT substrate 61, the opposite electrode substrate 62, the liquid crystal layer 63, the electrode layer 64, the opposite electrode 65, and the color filter 66, a transmissive liquid crystal display panel is formed. The TFT substrate 61 has a polarizing plate 67 disposed on a surface thereof opposite to the surface facing the liquid crystal layer 63. Similarly, the opposite electrode substrate 62 has a polarizing plate 68 disposed on a surface thereof opposite to the surface facing the liquid crystal layer 63.

The protective sheet 52 is disposed such that a surface, opposite to the opposite electrode substrate 62, of the polarizing plate 68 is covered with the protective sheet 52.

A back light unit 69 is disposed on the back side of the liquid crystal display panel such that the liquid crystal display panel is illuminated from its back side by light emitted from the back light unit 69 thereby displaying a color image on the liquid crystal display panel. The back light unit 69 may be configured in the form of an array of a plurality of light sources such as fluorescent tubes or light emitting diodes. It is desirable that the back light unit 69 be capable of being turned on/off at a high speed.

In the electrode layer 64, a plurality of optical sensors 22A serving as light sensing elements are formed. Each optical sensor 22A is disposed adjacent to a corresponding one of the light emitting elements of the liquid crystal display so that emitting light (to display an image) and sensing light (to read an input) can be performed at the same time.

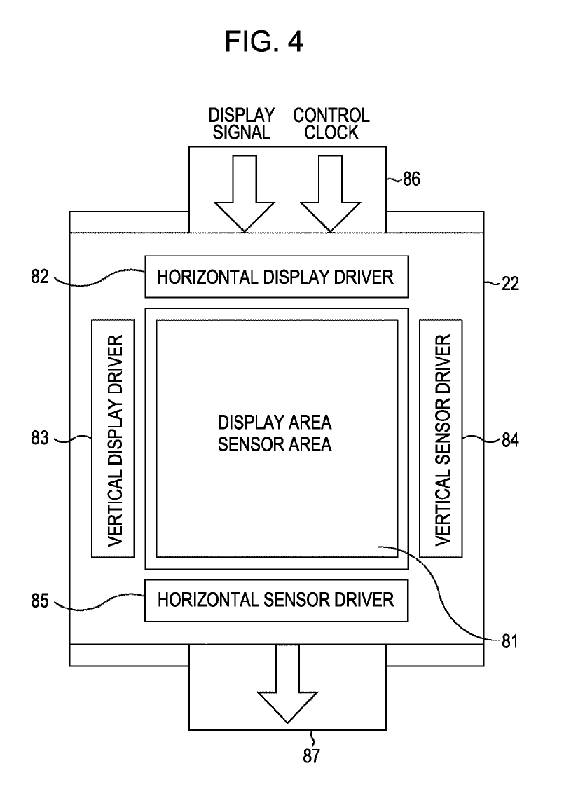

FIG. 4 illustrates an example of a manner in which drivers for controlling an operation of the input/output display 22 are disposed at various locations.

In the example shown in FIG. 4, a transparent display area (sensor area) 81 is formed in the center of the input/output display 22, and a horizontal display driver 82, a vertical display driver 83, a vertical sensor driver 84, and a horizontal sensor driver 85 are disposed in peripheral areas outwardly adjacent to respective four sides of the display area 81.

The horizontal display driver 82 and the vertical display driver 83 are adapted to drive pixels disposed in the form of an array in the display area 81 in accordance with a display signal and a control clock signal supplied as display image data supplied via an image signal line 86.

The vertical sensor driver 84 and the horizontal sensor driver 85 read a sensed light signal output from the optical sensor 22A in synchronization with a read clock signal (not shown) supplied from the outside, and supply the sensed light signal to the sensed light signal processing unit 23 shown in FIG. 1 via the sensed light signal line 87.

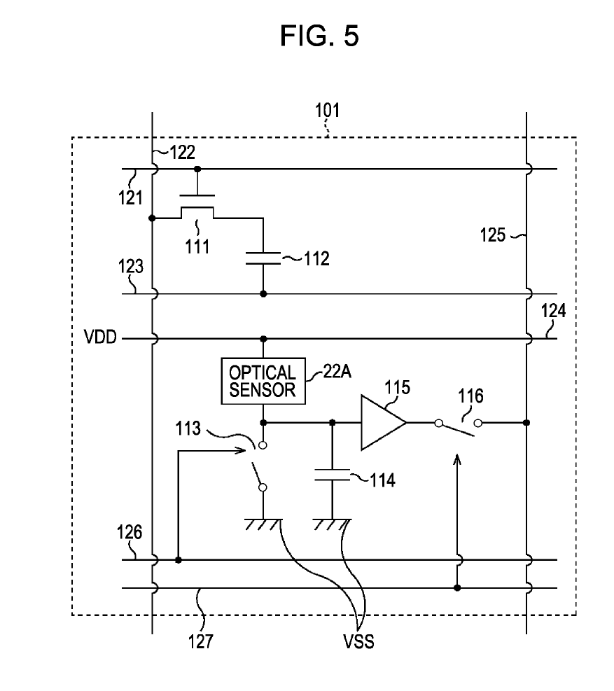

FIG. 5 illustrates an example of a circuit configuration of one of pixels disposed in the form of an array in the display area 81 of the input/output display 22. As shown in FIG. 5, each pixel 101 includes a thin film transistor (TFT) serving as an optical sensor 22A, a switching element 111, a pixel electrode 112, a reset switch 113, a capacitor 114, a buffer amplifier 115, and a switch 116. The switching element 111 and the pixel electrode 112 form a display part by which a displaying function is realized, while the optical sensor 22A, the reset switch 113, the capacitor 114, the buffer amplifier 115, and the switch 116 form a light sensing part by which a light sensing function is realized.

The switching element 111 is disposed at an intersection of a gate line 121 extending in a horizontal direction and a display signal line 122 extending in a vertical direction, and the gate of the switching element 111 is connected to the gate line 121 while the drain thereof is connected to the display signal line 122. The source of the switching element 111 is connected to one end of the pixel electrode 112. The other end of the pixel electrode 112 is connected to an interconnection line 123.

The switching element 111 turns on or off in accordance with a signal supplied via the gate line 121, and the displaying state of the pixel electrode 112 is determined by a signal supplied via the display signal line 122.

The optical sensor 22A is disposed adjacent to the pixel electrode 112, and one end of the optical sensor 22A is connected to a power supply line 124 via which a power supply voltage VDD is supplied, while the other end of the optical sensor 22A is connected to one end of the reset switch 113, one end of the capacitor 114, and an input terminal of the buffer amplifier 115. The other end (other than the end connected to the one end of the optical sensor 22A) of the reset switch 113 and the other end (other than the end connected to the one end of the optical sensor 22A) of the capacitor 114 are both connected to a ground terminal VSS. An output terminal of the buffer amplifier 115 is connected to a sensor signal line 125 via the read switch 116.

The turning-on/off of the reset switch 113 is controlled by a signal supplied via a reset line 126. The turning-on/off of the read switch 116 is controlled by a signal supplied via a read line 127.

The optical sensor 22A operates as follows.

First, the reset switch 113 is turned on thereby to reset the charge of the optical sensor 22A. Thereafter, the reset switch 113 is turned off. As a result, a charge corresponding to the amount of light incident on the optical sensor 22A is stored in the capacitor 114. In this state, if the read switch 116 is turned on, the charge stored in the capacitor 114 is supplied over the sensor signal line 125 via the buffer amplifier 115 and is finally output to the outside.

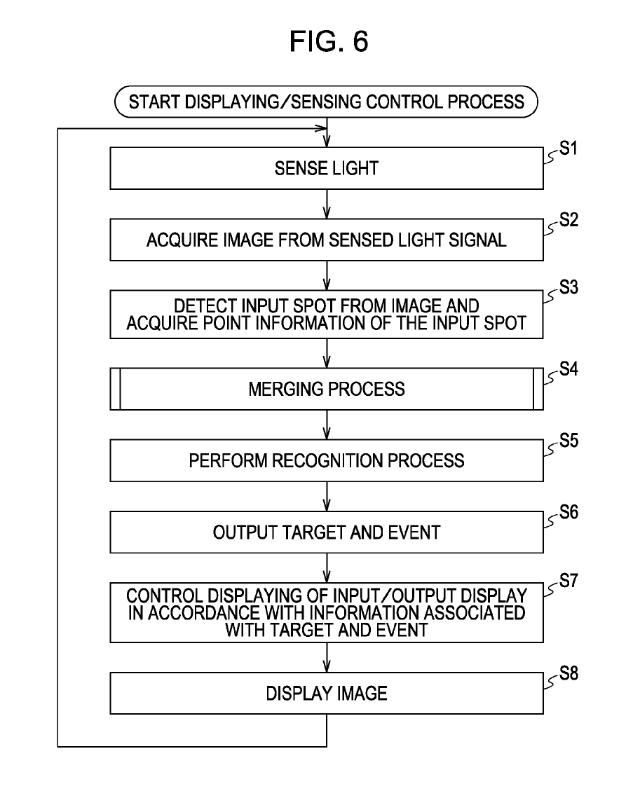

Next, referring to a flow chart shown in FIG. 6, a process of displaying an image and sensing light performed by the display system 1 is explained below.

This process of the display system 1 is started, for example, when a user turns on the power of the display system 1.

In the following explanation, it is assumed that step S1 to S8 have already been performed for frames up to a t-th frame, and target information and event information associated with, at least, frames before the t-th frame are already stored in the storage unit 33.

In step S1, the optical sensor 22A of the input/output display 22 detects light incident thereon from the outside, such as light reflected from a finger or the like located in contact with or close proximity to the display screen 51A and incident on the optical sensor 22A, and the optical sensor 22A supplies a sensed light signal corresponding to the amount of incident light to the sensed light signal processing unit 23.

In step S2, the sensed light signal processing unit 23 processes the sensed light signal supplied from the input/output display 22 so as to create an image of the (t+1)th frame whose brightness is different between an area where a user's finger is in contact with or close proximity to the display screen of the input/output display 22 and an area where nothing is contact with or close proximity to the display screen. The resultant image is supplied as an image of a (t+1)th frame to the image processing unit 24.

In step S3, the image processing unit 24 performs image processing, including binarization, noise removal, and labeling, on the image of the (t+1)th frame supplied from the sensed light signal processing unit 23 thereby to detect an input spot, in the (t+1)th frame, where the user's finger or the like is in contact with or close proximity to the display screen 51A of the input/output display 22. The image processing unit 24 supplies point information associated with the detected input spot to the generator 25.

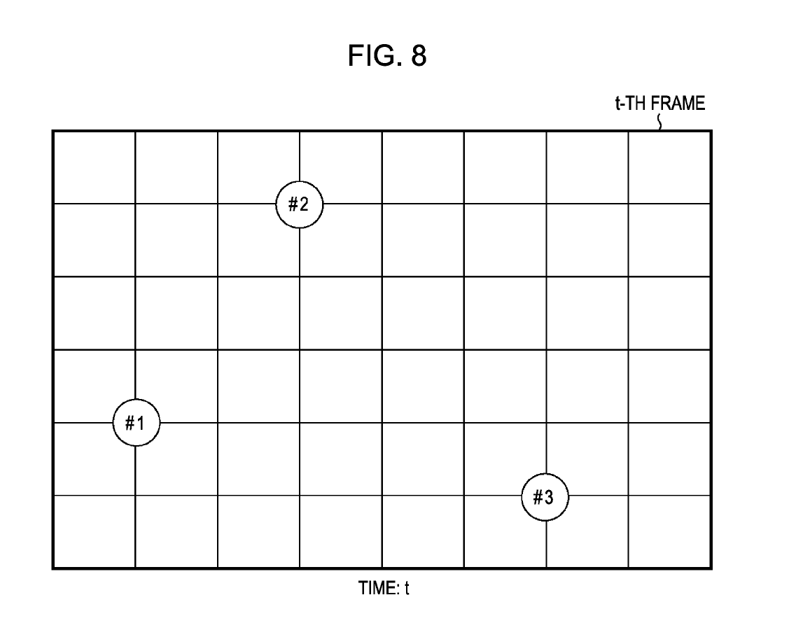

In step S4, the target generator 31 of the generator 25 performs the merging process on the point information associated with the input spot of the (t+1)th frame supplied from the image processing unit 24, and produces target information associated with the (t+1)th frame on the basis of the result of the merging process. The resultant target information is stored in the storage unit 33. Furthermore, the event generator 32 of the generator 25 performs the merging process on the basis of the target information to produce event information indicating an event which has occurred in the (t+1)th frame, such as appearing or disappearing of a target, if such an event has occurred. The resultant event information is stored in the storage unit 33. The merging process will be described in further detail later with reference to FIGS. 8 to 12.

In step S5, the event generator 32 of the generator 25 further performs the recognition process on the basis of the target information, and generates event information indicating a change in the status of the target in the (t+1)th frame. The resultant event information is stored in the storage unit 33.

For example, if the user moves his/her finger over the display screen 51A while maintaining the finger in contact with or close proximity to the display screen 51A, that is, if the target moves, then the event generator 32 generates an event “MoveStart” and stores information associated with the event “MoveStart” in the storage unit 33.

For example, if the user stops moving his/her finger on the display screen 51A, i.e., if the target stops, then the event generator 32 generates an event “MoveStop” and stores information associated with the event “MoveStop” in the storage unit 33.

In a case where the user brings his/her finger into contact with or close proximity to the display screen 51A, moves his/her finger a particular distance along the surface of the display screen 51A while maintaining the finger in contact with or close proximity to the display screen 51A, and finally moves his/her finger away from the display screen 51A, if the distance between the finger travel start point and the end point is equal to or greater than a predetermined threshold value, i.e., if the target disappears after a travel of a distance equal to or greater than the predetermined threshold value, the event generator 32 generates an event “Project” and stores information associated with the event “Project” in the storage unit 33.

In a case where the user brings his/her two fingers into contact with or close proximity to the display screen 51A, moves his/her two fingers so as to increase or decrease the distance between the two fingers while maintaining the two fingers in contact with or close proximity to the display screen 51A, and finally moves his/her two fingers away from the display screen 51A, then a determination is made as to whether the ratio of the final increased distance between the fingers to the initial distance is equal to or greater than a predetermined threshold value or the ratio of the final decreased distance between the two fingers to the initial distance is equal to or smaller than a predetermined threshold value. If the determination result is positive, the event generator 32 generates an event “Enlarge” or “Reduce” and stores information associated with the generated event in the storage unit 33.

In a case where the user brings his/her two fingers into contact with or close proximity to the display screen 51A, moves his/her two fingers along concentric arcs about a particular point on the display screen 51A while maintaining the two fingers in contact with or close proximity to the display screen 51A, and finally moves his/her two fingers away from the display screen 51A, then a determination is made as to whether the absolute value of the rotation angle between an initial line defined by initial positions of the two fingers in the initial frame on the display screen 51A and a final line defined by final positions of the two fingers in the final frame (the (t+1)th frame) on the display screen 51A is equal to or greater than a predetermined threshold value. If the determination result is positive, i.e., if the line defined by two targets rotates in either direction by an angle equal to or greater than the predetermined threshold value, the event generator 32 generates an event “Rotate” and stores information associated with the generated event in the storage unit 33.

In a case where the user brings his/her three fingers into contact with or close proximity to the display screen 51A, moves his/her three fingers along concentric arcs about a particular point on the display screen 51A while maintaining the three fingers in contact with or close proximity to the display screen 51A, and finally moves his/her three fingers away from the display screen 51A, then a calculation is performed to determine the rotation angle between an initial line defined by positions of two fingers of three fingers in an initial frame on the display screen 51A and a final line defined by final positions of the two fingers in the final frame (the (t+1)th frame) on the display screen 51A, for each of all possible combinations of two of three fingers. The average of angles of rotations made by respective combinations of two of three fingers is then calculated, and a determination is made as to whether the absolute value of the average rotation angle is equal to or greater than a predetermined threshold value. If the determination result is positive, i.e., if the average of rotation angles of three lines each defined by two of a total of three targets in a period from appearing and disappearing of the three targets is equal to or greater than the predetermined threshold value, the event generator 32 generates an event “ThreePointRotate” and stores information associated with the generated event in the storage unit 33.

In step S6, the event generator 32 of the generator 25 reads target information and event information associated with the (t+1)th frame from the storage unit 33 and supplies them to the controller 12.

In step S7, the controller 12 produces image data in accordance with the target/event information supplied from the generator 25 of the input/output panel 16 and supplies the resultant image data to the input/output display 22 via the display signal processing unit 21 thereby to change the mode in which the image is displayed on the input/output display 22, as required.

In step S8, in accordance with the command issued by the controller 12, the input/output display 22 changes the display mode in which an image is displayed. For example, the image is rotated by 900 in a clockwise direction and the resultant image is displayed.

The processing flow then returns to step S1 to perform the above-described process for a next frame, i.e., a (t+2)th frame.

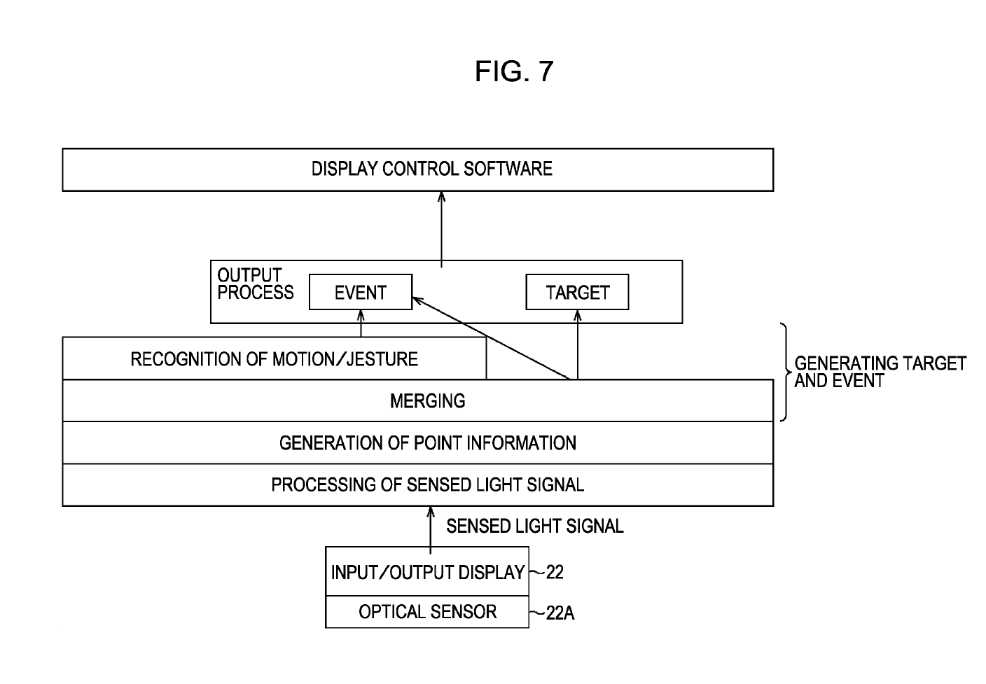

FIG. 7 illustrates an example of software configured to perform the displaying/sensing operation shown in FIG. 6.

The displaying/sensing software includes a sensed light processing software module, a point information generation software module, a merging software module, a recognition software module, an output software module, and a display control software module that is an upper-level application.

In FIG. 7, the optical sensor 22A of the input/output display 22 senses light incident from the outside and produces one frame of sensed light signal. As described above, the incident light is, for example, light reflected from a finger or the like in contact with or close proximity to the display screen 51A.

In the sensed light processing layer, sensed light processing including, for example, amplification, filtering, etc., is performed on the one frame of sensed light signal supplied from the input/output display 22 thereby to produce one frame of image corresponding to the one frame of sensed light signal.

In the point information generation layer, which is a layer immediately upper than the sensed light processing layer, image processing including, for example, binarization, noise removal, labeling, etc. is performed on the image obtained as a result of the sensed light processing, and an input spot is detected where the finger or the like is in contact with or close proximity to the display screen 51A of the input/output display 22. Point information associated with the input spot is then generated on a frame-by-frame basis.

In the merging layer, which is a layer immediately upper than the point information generation layer, a merging process is performed on the point information obtained as a result of the point information generation process, and target information is generated on a frame-by-frame basis. In accordance with the target information of the current frame, event information indicating an event such as generation or deleting (disappearing) of a target is generated.

In the recognition layer, which is a layer immediately upper than the merging layer, motion or gesture of a user's finger is recognized on the basis of the target information generated in the merging process, and event information indicating a change in the status of the target is generated on a frame-by-frame basis.

In the output layer, which is a layer immediately upper than the recognition layer, the target information and the event information generated in the merging process and event information generated in the recognition process are output on a frame-by-frame basis.

In the display control layer, which is an application layer upper than the output layer, in accordance with the target information and the event information output in the output process, image data is supplied, as required, to the input/output display 22 of the input/output panel 16 shown in FIG. 1 thereby changing the mode in which the image is displayed on the input/output display 22.

Next, referring to FIGS. 8 to 12, the merging process performed by the generator 25 shown in FIG. 1 is described in further detail.

FIG. 8 illustrates targets existing in a t-th frame at time t.

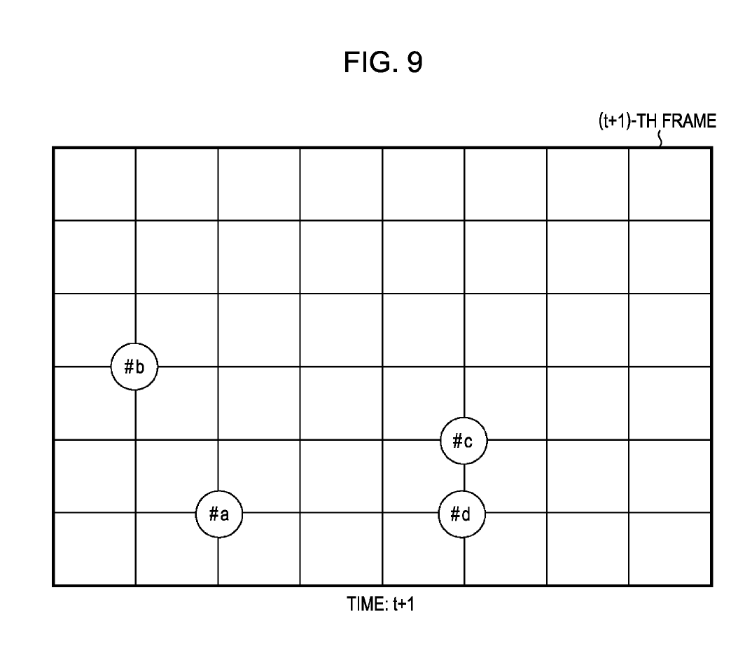

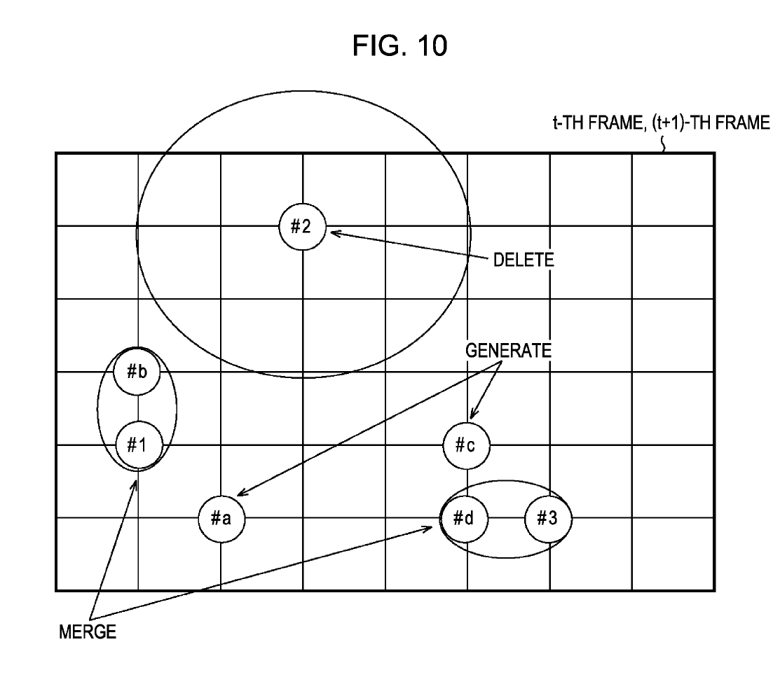

In FIG. 8 (and also in FIGS. 9 and 10 which will be referred to later), for convenience of illustration, a grid is displayed on the frame.

In FIG. 8, there are three targets #1, #2, and #3 in the t-th frame at time t. An attribute may be defined for each target. The attribute may include a target ID (identifier) serving as identification information identifying each target. In the example shown in FIG. 8, #1, #2, and #3 are assigned as target IDs to the respective three targets.

Such three targets #1, #2, and #3 can appear, for example, when three user's fingers are in contact with or close proximity to the display screen 51A of the input/output display 22.

FIG. 9 illustrates a (t+1)th frame at time t+1 following the t-th frame at time t, in a state in which the merging process is not yet performed.

In the example shown in FIG. 9, there are four input spots #a to #d in the (t+1)th frame.

Such a state in which four input spots #a to #d appear can occur, for example, when four user's fingers are in contact with or close proximity to the display screen 51A of the input/output display 22.

FIG. 10 is a diagram in which both the t-th frame shown in FIG. 8 and the (t+1)th frame shown in FIG. 9 are shown in a superimposed manner.

In the merging process, a comparison in terms of input spots is made between two frames such as the t-th frame and the (t+1)th frame, which are temporally close to each other. When a particular target in the t-th frame is taken as a target of interest in the merging process, if an input spot spatially close to the target of interest is detected, the input spot is regarded as one of a sequence of input spots belonging to the target of interest, and thus the detected input spot is merged into the target of interest. The determination as to whether a particular input spot belongs to a particular target may be made by determining whether the distance between the input spot and the target is smaller than a predetermined threshold value (for example, a distance corresponding to blocks of the grid).

In a case where there are a plurality of input spots spatially close to the target of interest, an input spot closest to the target of interest is selected from the plurality of input spots and the selected input spot is merged into the target of interest.

In the merging process, when no input spot is detected which is spatially close to the target of interest, it is determined that inputting by the sequence of input spots is completed, and the target of interest is deleted.

Furthermore, in the merging process, if an input spot remaining without being merged with any target is detected, that is, if an input spot is detected at a location not spatially close to any target, it is determined that inputting by a sequence of input spots has been newly started, and thus a new target is created.

In the example shown in FIG. 10, the merging process is performed by checking the locations of the input spots #a to #d in the (t+1)th frame relative to the locations of the targets #1 to #3 in the t-th frame. In this example, input spots #a and #b are detected at locations close to the target #1. The input spot #b is determined as being closer to the target #1 than the input spot #a, and thus the input spot #b is merged with the target #1.

In the example shown in FIG. 10, there is no input spot spatially close to the target #2, and thus the target #2 is deleted. In this case, an event “Delete” is generated to indicate that the target has been deleted.

In the example shown in FIG. 10, the input spots #c and #d are located close to the target #3. In this specific case, the input spot #d is closer to the target #3 than the input spot #c, and thus the input spot #d is merged with the target #3.

The input spots #a and #c finally remain without being merged with any of the targets #1 to #3. Thus, new targets are created for these two spots, and an event “Create” is generated to indicate that new targets have been created.

In the merging process, the targets remaining in the t-th frame without being deleted and the newly created targets corresponding to the input spots remaining without being merged with any existing target in the (t+1)th frame are employed as targets in the (t+1)th frame. Target information associated with (t+1)th frame is then produced on the basis of point information associated with the input spots in the (t+1)th frame.

Point information associated with an input spot is obtained by performing image processing on each frame of sensed light image supplied to the image processing unit 24 from the sensed light signal processing unit 23.

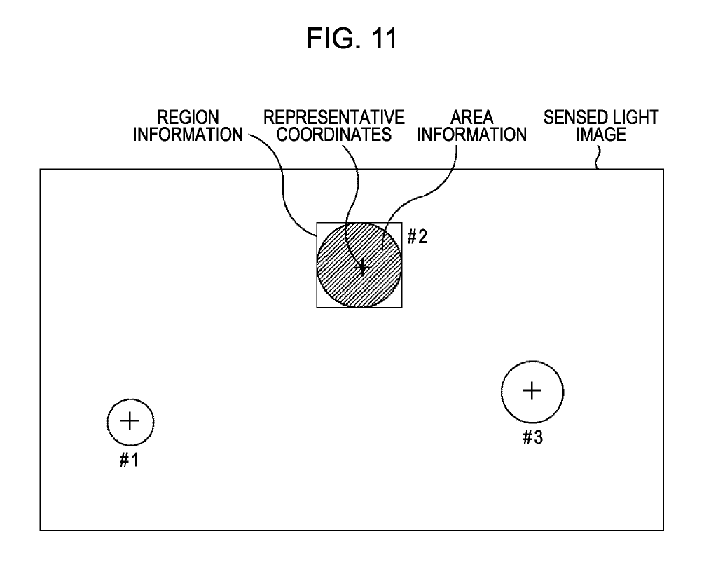

FIG. 11 illustrates an example of a sensed light image.

In the example shown in FIG. 11, the sensed light image includes three input spots #1 to #3.

Each input spot on the sensed light image is a spot where light is sensed which is incident after being reflected from a finger in contact with or close proximity to the display screen 51A. Therefore, each input spot has greater or lower brightness compared with other areas where there is no finger in contact with or close proximity to the display screen 51A. The image processing unit 24 detects an input spot by detecting an area having higher or lower brightness from the sensed light image, and outputs point information indicating a feature value of the input spot.

As for point information, information indicating the location of a representative point of an input spot and information indicating the region or the size of the input spot may be employed. More specifically, for example, coordinates of the center of an input spot (for example, the center of a smallest circle completely containing the input spot) or coordinates of the barycenter of the input spot may be employed to indicate the location of the representative point of the input spot. The size of the input spot may be represented by the area of the input spot (shaded in FIG. 11). The region of the input spot may be represented, for example, by a set of coordinates of an upper end, lower end, a left end, and a right end of a smallest rectangle completely containing the input spot.

The target attribute information in the target information is produced on the basis of the point information of the input spot merged with the target. More specifically, for example, when an input spot is merged with a target, a target ID serving as identification information uniquely assigned to the target is maintained, but the other items of the target attribute information such as the representative coordinates, the area information, the region information, etc. are replaced by the representative coordinates, the area information, and the region information of the input spot merged with the target.

Target attribute information may include information indicating a start time of a target by which a sequence of inputting is performed and information indicating an end time of the target.

In addition to the target attribute information, the target information may further include, for example, information indicating the number of targets of each frame output from the generator 25 to the controller 12.

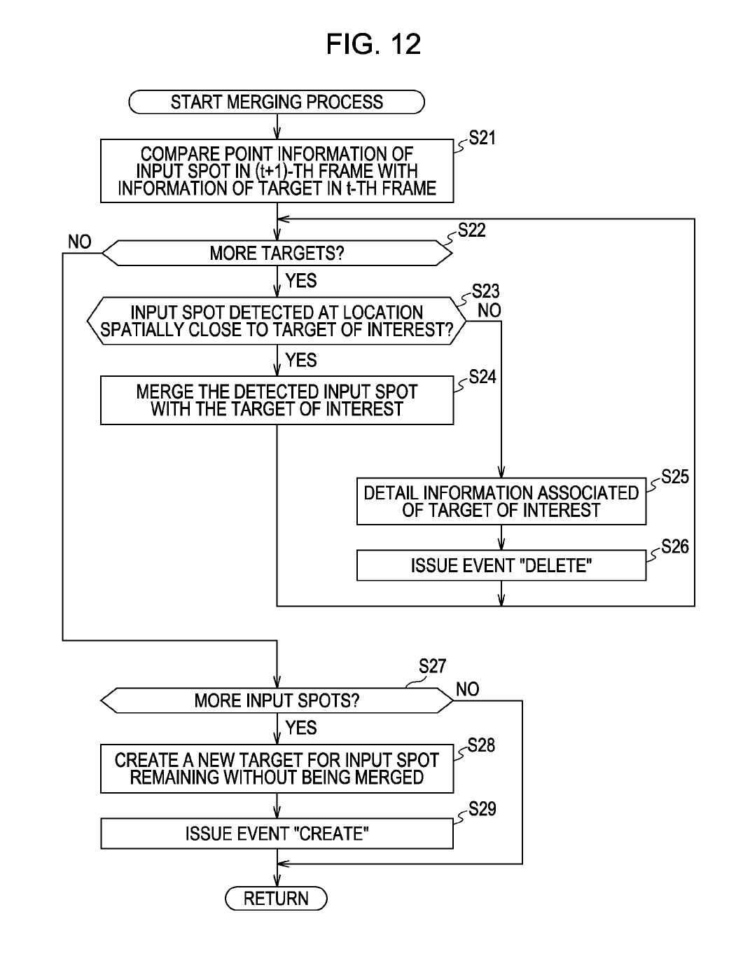

Next, referring to a flow chart shown in FIG. 12, the merging process performed in step S4 in FIG. 6 by the generator 25 shown in FIG. 1 is described in further detail below.

In step S21, the target generator 31 reads target information associated with the t-th frame temporally close to the (t+1)th frame from the storage unit 33, and compares the point information of input spots in the (t+1)th frame supplied from the image processing unit 24 with the target information associated with the t-th frame read from the storage unit 33.

In step S22, the target generator 31 determines whether there are targets remaining without being examined as a target of interest in the t-th frame read in step S21. If the determination in step S22 is that there are more targets remaining without being examined as a target of interest in the t-th frame read in step S21, then in step S23, the target generator 31 selects one of such targets as a target of interest from the targets in the t-th frame, and the target generator 31 determines whether the (t+1)th frame has an input spot spatially close to the target of interest in the t-th frame.

If the determination in step S23 is that the (t+1)th frame has an input spot spatially close to the target of interest in the t-th frame, then, in step S24, the target generator 31 merges this input spot in the (t+1)th frame, determined in step S22 as being located spatially close to the target of interest, into the target of interest. Target information associated with the target of interest in the state in which the merging has been performed is then produced and stored, as target information associated with the (t+1)th frame, in the storage unit 33.

More specifically, the target generator 31 keeps the target ID of the target interest but replaces the other items of the target attribute information including the representative coordinates of the target of interest with those of the input spot merged into the target of interest, and the target generator 31 stores the resultant target information of the (t+1)th frame in the storage unit 33.

On the other hand, in a case where the determination in step S23 is that the (t+1)th frame has no input spot spatially close to the target of interest in the t-th frame, then in step S25, the target generator 31 deletes information associated with the target of interest from the storage unit 33.

In step S26, in response to deleting of the target of interest by the target generator 31, the event generator 32 issues an event “Delete” to indicate that the sequence of inputting corresponding to the target is completed, and stores event information associated with the event, as event information of the (t+1)th frame, in the storage unit 33. In the example shown in FIG. 10, when the target #2 is taken as the target of interest, an event “Delete” is issued to indicate that the target #2 has been deleted from the (t+1)th frame, and information associated with the event “Delete” is stored in the storage unit 33.

After step S24 or S26, the processing flow returns to step S22 to perform the process described above for a new target of interest.

On the other hand, if the determination in step S22 is that there are no more targets remaining without being examined as the target of interest in the t-th frame read in step S21, then in step S27, the target generator 31 determines whether the (t+1)th frame supplied from the image processing unit 24 has an input spot remaining without being merged with any target of the t-th frame.

In a case where the determination in step S27 is that the (t+1)th frame has an input spot remaining without being merged with any target of the t-th frame, the processing flow proceeds to step S28. In step S28, the target generator 31 creates a new target for the input spot remaining without being merged.

More specifically, if an input spot remaining without being merged with any target in the t-th frame is detected in the (t+1)th frame, i.e., if an input spot which is spatially not close to any target is detected, it is determined that inputting by a new sequence of input spots has been started, and a new target is created. The target generator 31 produces information associated with the new target and stores it, as target information associated with the (t+1)th frame, in the storage unit 33.

In step S29, in response to creating the new target by the target generator 31, the event generator 32 issues an event “Create” and stores information associated with the event “Create” as event information associated with the (t+1)th frame in the storage unit 33. The merging process is then ended and the processing flow returns to step S5 in FIG. 6.

On the other hand, if the determination in step S27 is that the (t+1)th frame has no input spot remaining without being merged with any target of the t-th frame, steps S28 and S29 are skipped, and the merging process is ended. The processing flow then returns to step S5 in FIG. 6.

In the merging process described above, if a target which is not spatially close to any input spot of the (t+1)th frame is detected in the t-th frame, information associated with the detected target is deleted. Alternatively, when such a target is detected in the t-th frame, the information associated with the detected target may be maintained for a following few frames. If no input spot appears at a location spatially close to the target in the following few frames, the information may be deleted. This ensures that even when a user moves his/her finger away from the display screen for a very short time by mistake, if the user creates an input spot by bringing again his/her finger into contact with or close proximity to the display screen 51A, the input spot is correctly merged with the target.

In the merging process, as described above, an input spot spatially and temporally close to a target is detected on the display screen 51A of the input/output display 22, it is determined that the detected input spot is one of a sequence of input spots, and the detected input spot is merged with the target. In the merging process, if a target is created or deleted, an event is issued to indicate that the target has been created or deleted.

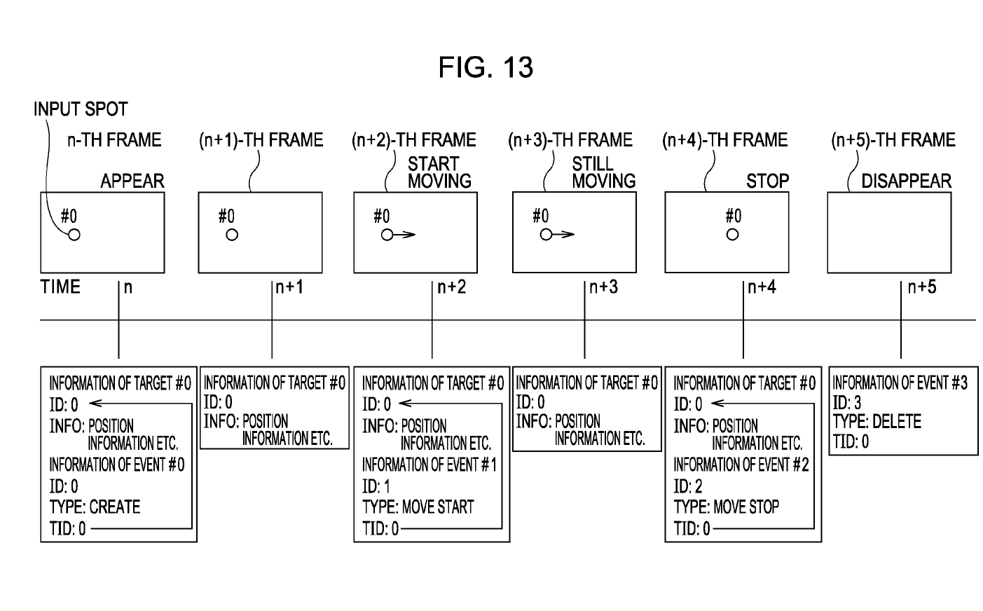

FIG. 13 illustrates an example of a manner in which target information and event information are output by the generator 25.

On the top of FIG. 13, a sequence of frames from an n-th frame at time n to (n+5)th frame at time n+5 are shown. In these frames, an input spot on the sensed light image is denoted by an open circle. On the bottom of FIG. 13, target information and event information associated with each of frames from the n-th frame to the (n+5)th frame are shown.

In the sequence of frames shown on the top of FIG. 13, a user brings his/her one of fingers into contact with or close proximity to the display screen 51A of the input/output display 22 at time n. The finger is maintained in the contact with or close proximity to the display screen 51A of the input/output display 22 over a period from time n to time n+4. In the (n+2)th frame, the user starts moving the finger in a direction from left to right while maintaining the finger in contact or close proximity to the display screen 51A. In the (n+4)th frame, the user stops moving the finger. At time n+5, the user moves the finger away from the display screen 51A of the input/output display 22. In response to the above-described motion of the finger, an input spot #0 appears, moves, and disappears as shown in FIG. 13.

More specifically, the input spot #0 appears in the n-th frame in response to bringing the user's finger into contact with or close proximity to the display screen 51A of the input/output display 22, as shown on the top of FIG. 13.

In response to appearing of the input spot #0 in the n-th frame, the target #0 is created, and target attribute information including a target ID and other items of target attribute information is produced, as shown on the bottom of FIG. 13. Hereinafter target attribute information other than the target ID will be referred simply as information associated with the target and will be denoted by INFO. In the example shown in FIG. 13, 0 is assigned as the target ID to the target #0, and associated information INFO including information indicating the position of the input spot #0 is produced.

Note that an entity of a target is a storage area allocated in a memory to store the target attribute information.

In the n-th frame, in response to creating of the target #0, an event #0 is produced. As shown on the bottom of FIG. 13, the event #0 produced herein in the n-th frame has items including an event ID assigned 0 to identify the event, an event type having a value of “Create” indicating that a new target has been created, and identification information tid having the same value 0 as that of the target ID of the target #0 so as to indicate that this event #0 represents the status of the target #0.

Note that an event whose event type is “Create” indicating that a new target has been created is denoted as an event “Create”.

As described above, each event has, as one item of event attribute information, identifying information tid identifying a target whose status is indicated by the event. Thus, from the identification information tid, it is possible to determine which target is described by the event.

Note that an entity of an event is a storage area allocated in a memory to store the event attribute information.

In the (n+1)th frame, as shown on the top of FIG. 13, the input spot #0 remains at the same location as in the previous frame.

In this case, the input spot #0 in the (n+1)th frame is merged with the target #0 in the immediately previous frame, i.e., the n-th frame. As a result, in the (n+1)th frame, as shown on the bottom of FIG. 13, the target #0 has the same ID as that in the previous frame and has associated information INFO updated by information including position information of the input spot #0 in the (n+1)th frame. That is, the target ID (=0) is maintained, but the associated information INFO is replaced with the information including the position information of the input spot #0 in the (n+1)th frame.

In the (n+2)th frame, as shown on the top of FIG. 13, the input spot #0 starts moving.

In this case, the input spot #0 of the (n+2)th frame is merged with the target #0 of the immediately previous frame, i.e., the (n+1)th frame. As a result, in the (n+2)th frame, as shown on the bottom of FIG. 13, the target #0 has the same ID as that in the previous frame and has associated information INFO updated by information including position information of the input spot #0 in the (n+2)th frame. That is, the target ID (=0) is maintained, but the associated information INFO is replaced with the information including the position information of the input spot #0 in the (n+2)th frame.

Furthermore, in the (n+2)th frame, in response to the start of moving of the input spot #0 merged with the target #0, i.e., in response to the start of moving of the target #0, an event #1 is produced. More specifically, as shown on the bottom of FIG. 13, the event #1 produced herein in the (n+2)th frame includes, as items, an event ID having a value of 1 that is different from the event ID assigned to the event produced in the n-th frame, an event type having a value of “MoveStart” indicating that the corresponding target started moving, and identification information tid assigned the same value 0 as that of the target ID of the target #0 that has started moving so as to indicate that this event #1 represents the status of the target #0.

In the (n+3)th frame, as shown on the top of FIG. 13, the input spot #0 is still moving.

In this case, the input spot #0 of the (n+3)th frame is merged with the target #0 of the immediately previous frame, i.e., the (n+2)th frame. As a result, in the (n+3)th frame, as shown on the bottom of FIG. 13, the target #0 has the same ID as that in the previous frame and has associated information INFO updated by information including position information of the input spot #0 in the (n+3)th frame. That is, the target ID (=0) is maintained, but the associated information INFO is replaced with the information including the position information of the input spot #0 in the (n+3)th frame.

In the (n+4)th frame, as shown on the top of FIG. 13, the input spot #0 stops.

In this case, the input spot #0 of the (n+4)th frame is merged with the target #0 of the immediately previous frame, i.e., the (n+3)th frame. As a result, in the (n+4)th frame, as shown on the bottom of FIG. 13, the target #0 has the same ID as that in the previous frame and has associated information INFO updated by information including position information of the input spot #0 in the (n+4)th frame. That is, the target ID (=0) is maintained, but the associated information INFO is replaced with the information including the position information of the input spot #0 in the (n+4)th frame.

Furthermore, in the (n+4)th frame, in response to the end of moving of the input spot #0 merged with the target #0, i.e., in response to the end of moving of the target #0, an event #2 is produced. More specifically, as shown on the bottom of FIG. 13, the event #2 produced herein in the (n+4)th frame has items including an event ID having a value of 2 that is different from the event IDs assigned to the events produced in the n-th or (n+2)th frame, an event type having a value of “MoveStop” indicating that the corresponding target stopped moving, and identification information tid assigned the same value 0 as that of the target ID of the target #0 that has stopped moving so as to indicate that this event #2 represents the status of the target #0.

In the (n+5)th frame, the user moves his/her finger away from the display screen 51A of the input/output display 22, and thus the input spot #0 disappears, as shown on the top of FIG. 13.

In this case, in the (n+5)th frame, the target #0 is deleted.

Furthermore, in the (n+5)th frame, in response to disappearing of the input spot #0, i.e., in response to deleting of the target #0, an event #3 is produced. More specifically, as shown on the bottom of FIG. 13, the event #3 produced herein in the (n+5)th frame has items including an event ID having a value of 3 that is different from the event IDs assigned to the events produced in the n-th, (n+2)th, or (n+4)th frame, an event type having a value of “Delete” indicating that the corresponding target has been deleted, and identification information tid assigned the same value 0 as that of the target ID of the target #0 that has been deleted so as to indicate that this event #3 represents the status of the target #0.

Note that an event whose event type is “Delete” indicating that a target has been deleted is denoted as an event “Delete”.

FIG. 14 illustrates another example of a manner in which target information and event information are output by the generator 25.

On the top of FIG. 14, a sequence of frames from an n-th frame at time n to (n+5)th frame at time n+5 are shown. In these frames, an input spot on the sensed light image is denoted by an open circle. On the bottom of FIG. 14, target information and event information associated with each of frames from the n-th frame to the (n+5)th frame are shown.

In the sequence of frames shown in FIG. 14, a user brings his/her one finger into contact with or close proximity to the display screen 51A of the input/output display 22 at time n. The finger is maintained in the contact with or close proximity to the display screen 51A of the input/output display 22 over a period from time n to time n+4. In the (n+2)th frame, the user starts moving the finger in a direction from left to right while maintaining the finger in contact or close proximity to the display screen 51A. In the (n+4)th frame, the user stops moving the finger. At time n+5, the user moves the finger away from the display screen 51A of the input/output display 22. In response to the above-described motion of the finger, an input spot #0 appears, moves, and disappears as shown in FIG. 14.

Furthermore, as shown in FIG. 14, a user brings his/her another one of fingers into contact with or close proximity to the display screen 51A of the input/output display 22 at time n+1. This finger (hereinafter referred to as a second finger) is maintained in the contact with or close proximity to the display screen 51A of the input/output display 22 over a period from time n+1 to time n+3. In the (n+2)th frame, the user starts moving the second finger in a direction from right to left while maintaining the finger in contact or close proximity to the display screen 51A. In the (n+3)th frame, the user stops moving the second finger. At time n+4, the user moves the second finger away from the display screen 51A of the input/output display 22. In response to the above-described motion of the second finger, an input spot #1 appears, moves, and disappears as shown in FIG. 14.

More specifically, the input spot #0 appears in the n-th frame in response to bringing the user's first one of fingers into contact with or close proximity to the display screen 51A of the input/output display 22, as shown on the top of FIG. 14.

In response to appearing of the input spot #0 in the n-th frame, the target #0 is created, and target attribute information including a target ID and other items of target attribute information is produced, as shown on the bottom of FIG. 14, in a similar manner to the example shown in FIG. 13. Hereinafter target attribute information other than the target ID will be referred simply as information associated with the target and will be denoted by INFO. In the example shown in FIG. 14, 0 is assigned as the target ID to the target #0, and associated information INFO including information indicating the position of the input spot #0 is produced.

In the n-th frame, in response to creating of the target #0, an event #0 is produced. More specifically, as shown on the bottom of FIG. 14, the event #0 produced herein in the n-th frame includes, as items, an event ID having a value of 0, an event type having a value of “Create” indicating that a new target has been created, and identification information tid having the same value 0 as that of the target ID of the target #0 so as to indicate that this event #0 represents the status of the target #0.

In the (n+1)th frame, as shown on the top of FIG. 14, the input spot #0 remains at the same location as in the previous frame.

In this case, the input spot #0 in the (n+1)th frame is merged with the target #0 in the immediately previous frame, i.e., the n-th frame. As a result, in the (n+1)th frame, as shown on the bottom of FIG. 14, the target #0 has the same ID as that in the previous frame and has associated information INFO updated by information including position information of the input spot #0 in the (n+1)th frame. That is, the target ID (=0) is maintained, but the associated information INFO is replaced with the information including the position information of the input spot #0 in the (n+1)th frame.

Also in this (n+1)th frame, in response to bringing of user's another one of fingers into contact with or close proximity to the display screen 51A of the input/output display 22, the input spot #1 also appears, as shown on the top of FIG. 14.

In response to appearing of the input spot #1 in the (n+1)th frame, the target #1 is created, and attributes thereof are defined such that a target ID is defined so as to have a value of 1 different from the target ID assigned to the already existing target #0, and associated information INFO including information indicating the position of the input spot #1 is produced.

Furthermore, in the (n+1)th frame, in response to creating of the target #1, an event #1 is produced. More specifically, as shown on the bottom of FIG. 14, the event #1 produced herein in the (n+1)th frame includes, as items, an event ID having a value of 1 that is different from the event ID assigned to the event produced in the n-th frame, an event type having a value of “Create” indicating that a new target has been created, and identification information tid having the same value 1 as that of the target ID of the target #1 so as to indicate that this event #1 represents the status of the target #1.

In the (n+2)th frame, as shown on the top of FIG. 14, the input spots #0 and #1 start moving.

In this case, the input spot #0 of the (n+2)th frame is merged with the target #0 of the immediately previous frame, i.e., the (n+1)th frame. As a result, as shown on the bottom of FIG. 14, the target #0 has the same ID as that in the previous frame and has associated information INFO updated by information including position information of the input spot #0 in the (n+2)th frame. That is, the target ID (=0) is maintained, but the associated information INFO is replaced with the information including the position information of the input spot #0 in the (n+2)th frame.

Furthermore, the input spot #1 of the (n+2)th frame is merged with the target #1 of the (n+1)th frame. As a result, as shown on the bottom of FIG. 14, the target #1 has the same ID as that in the previous frame and has associated information INFO updated by information including position information of the input spot #1 in the (n+2)th frame. That is, the target ID is maintained at the same value, i.e., 1, but the associated information INFO is replaced with the information including the position information of the input spot #1 in the (n+2)th frame.

Furthermore, in this (n+2)th frame, in response to the start of moving of the input spot #0 merged with the target #0, i.e., in response to the start of moving of the target #0, an event #2 is produced. More specifically, as shown on the bottom of FIG. 14, the event #2 produced herein in the (n+2)th frame has items including an event ID having a value of 2 that is different from any event ID assigned to the already produced event #0 or #1, an event type having a value of “MoveStart” indicating that the corresponding target started moving, and identification information tid assigned the same value 0 as that of the target ID of the target #0 that has started moving so as to indicate that this event #2 represents the status of the target #0.

Also in this (n+2)th frame, in response to the start of moving of the input spot #1 merged with the target #1, i.e., in response to the start of moving of the target #1, an event #3 is produced. More specifically, as shown on the bottom of FIG. 14, the event #3 produced herein in the (n+2)th frame has items including an event ID having a value of 3 that is different from any event ID assigned to the already produced events #0 to #2, an event type having a value of “MoveStart” indicating that the corresponding target started moving, and identification information tid assigned the same value 1 as that of the target ID of the target #1 that has started moving so as to indicate that this event #3 represents the status of the target #1.

In the (n+3)th frame, as shown on the top of FIG. 14, the input spot #0 is still moving.

In this case, the input spot #0 of the (n+3)th frame is merged with the target #0 of the immediately previous frame, i.e., the (n+2)th frame. As a result, in the (n+3)th frame, as shown on the bottom of FIG. 14, the target #0 has the same ID as that in the previous frame and has associated information INFO updated by information including position information of the input spot #0 in the (n+3)th frame. That is, the target ID (=0) is maintained, but the associated information INFO is replaced with the information including the position information of the input spot #0 in the (n+3)th frame.

In this (n+3)th frame, the input spot #1 stops.

In this case, the input spot #1 of the (n+3)th frame is merged with the target #1 of the immediately previous frame, i.e., the (n+2)th frame. As a result, in the (n+3)th frame, as shown on the bottom of FIG. 14, the target #1 has the same ID as that in the previous frame and has associated information INFO updated by information including position information of the input spot #1 in the (n+3)th frame. That is, the target ID is maintained at the same value, i.e., 1, but the associated information INFO is replaced with the information including the position information of the input spot #1 in the (n+3)th frame.

Furthermore, in the (n+3)th frame, in response to the end of moving of the input spot #1 merged with the target #1, i.e., in response to the end of moving of the target #1, an event #4 is produced. More specifically, as shown on the bottom of FIG. 14, the event #4 produced herein in the (n+3)th frame includes, as items, an event ID having a value of 4 that is different from any event ID assigned to the already produced events #0 to #3, an event type having a value of “MoveStop” indicating that the corresponding target stopped moving, and identification information tid assigned the same value 1 as that of the target ID of the target #1 that has stopped moving so as to indicate that this event #4 represents the status of the target #1.

In the (n+4)th frame, the user moves his/her second finger away from the display screen, and thus the input spot #1 disappears, as shown on the top of FIG. 14.

In this case, in the (n+4)th frame, the target #1 is deleted.

Furthermore, in this (n+4)th frame, as shown on the top of FIG. 14, the input spot #0 stops.

In this case, the input spot #0 of the (n+4)th frame is merged with the target #0 of the immediately previous frame, i.e., the (n+3)th frame. As a result, in the (n+4)th frame, as shown on the bottom of FIG. 14, the target #0 has the same ID as that in the previous frame and has associated information INFO updated by information including position information of the input spot #0 in the (n+4)th frame. That is, the target ID is maintained at the same value, i.e., 0, but the associated information INFO is replaced with the information including the position information of the input spot #0 in the (n+4)th frame.

Also in this (n+4)th frame, in response to the end of moving of the input spot #0 merged with the target #0, i.e., in response to the end of moving of the target #0, an event #5 is produced. More specifically, as shown on the bottom of FIG. 14, the event #5 produced herein in the (n+4)th frame includes, as items, an event ID having a value of 5 that is different from any event ID assigned to the already produced events #0 to #4, an event type having a value of “MoveStop” indicating that the corresponding target stopped moving, and identification information tid assigned the same value 0 as that of the target ID of the target #0 that has stopped moving so as to indicate that this event #5 represents the status of the target #0.

Still furthermore, in this (n+4)th frame, in response to disappearing of the input spot #1, i.e., in response to deleting of the target #1, an event #6 is produced. More specifically, as shown on the bottom of FIG. 14, the event #6 produced herein in the (n+4)th frame has items including an event ID having a value of 6 that is different from any event ID assigned to the already produced events #0 to #5, an event type having a value of “Delete” indicating that the corresponding target has been deleted, and identification information tid assigned the same value 1 as that of the target ID of the target #1 that has been deleted so as to indicate that this event #6 represents the status of the target #1.

In the (n+5)th frame, the user moves his/her first finger away from the display screen 51A of the input/output display 22, and thus the input spot #0 disappears, as shown on the top of FIG. 14.

In this case, the target #0 is deleted from the (n+5)th frame.

Furthermore, in the (n+5)th frame, in response to disappearing of the input spot #0, i.e., in response to deleting of the target #0, an event #7 is produced. More specifically, as shown on the bottom of FIG. 14, the event #7 produced herein in the (n+5)th frame has items including an event ID having a value of 7 that is different from any event ID assigned to the already produced events #0 to #6, an event type having a value of “Delete” indicating that the corresponding target has been deleted, and identification information tid assigned the same value 0 as that of the target ID of the target #0 that has been deleted so as to indicate that this event #7 represents the status of the target #0.

As described above, even when inputting is performed for a plurality of spots on the input/output panel 16 at the same time, target information is produced for each sequence of input spots in accordance with temporal and spatial relationships among input spots, and event information indicating a change in the status of each target is produced thereby making it possible to input information using a plurality of spots at the same time.

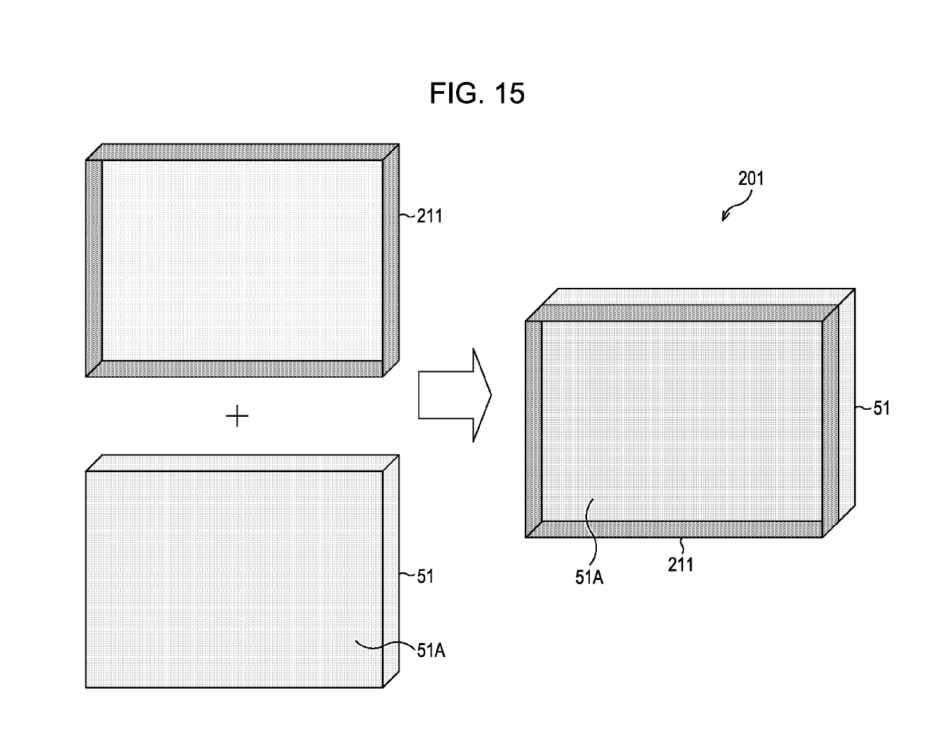

Next, referring to FIGS. 15 to 17, other examples of configurations of the input/output display are described below.

In the example shown in FIG. 15, the protective sheet 52 of the input/output display 201 shown in FIG. 2 is replaced by a protective sheet 211. Unlike the protective sheet 52, the protective sheet 211 is made of a translucent colored material.

By coloring the protective sheet 211, it is possible to improve the appearance of the input/output panel 16.

User of a translucent colored material makes it possible to minimize the degradation in visibility and the light sensitivity due to the protective sheet 211. For example, when the optical sensor 22A has high sensitivity to light with wavelengths smaller than 460 nm (i.e., to blue or nearly blue light), that is, when the optical sensor 22A is capable of easily detecting light with wavelengths smaller than 460 nm, if the protective sheet 211 is made of a blue translucent material, it is possible to maintain high sensitivity of the optical sensor 22A to blue light compared with other colors.

In the example shown in FIG. 16, the protective sheet 52 of the input/output display 221 shown in FIG. 2 is replaced by a protective sheet 231.

The protective sheet 231 has guides 231A to 231E formed in a recessed or raised shape on its one surface opposite to the surface in contact with the main body 51. Each of the guides 231A to 231E may be configured so as to have a shape corresponding to a button or a switch serving as a user interface displayed on the input/output display 22. The protective sheet 231 is connected to the main body 51 so that the guides 231A to 231E are located substantially exactly above corresponding user interfaces displayed on the display screen 51A so that when a user touches the protective sheet 231, the sense of touch allows the user to recognize the type and the location of each user interface displayed on the display screen 51A. This makes it possible for the user to operate the input/output display 22 without having to look at the display screen 51A. Thus, a great improvement in the operability of the display system 1 can be achieved.

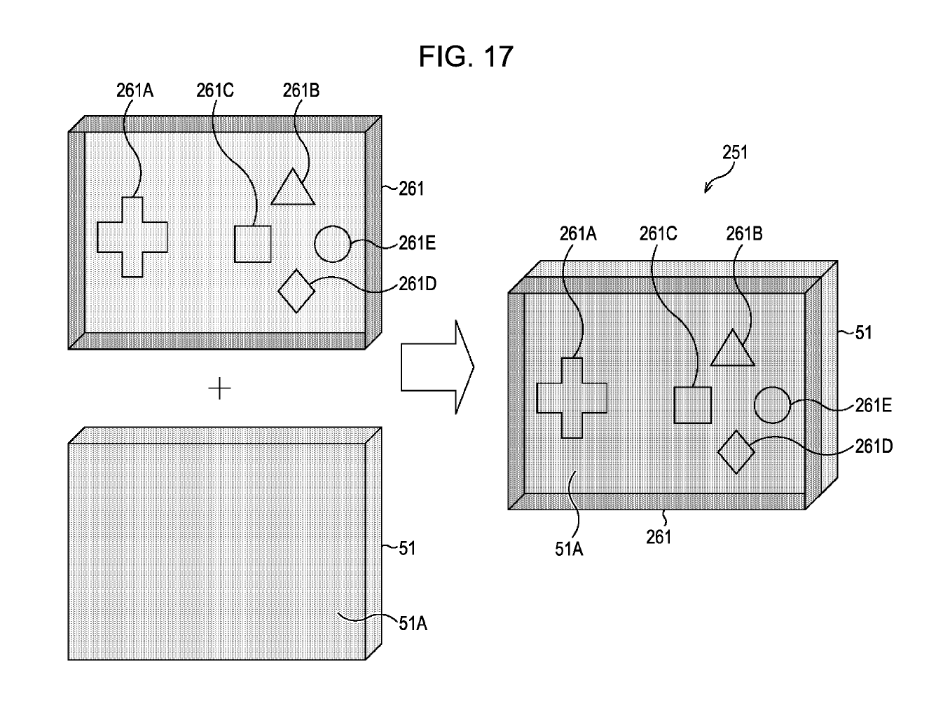

In the example shown in FIG. 17, the protective sheet 52 of the input/output display 251 shown in FIG. 2 is replaced by a protective sheet 261.

The protective sheet 261 is made of a translucent colored material such that the protective sheet 261 has guides 261A to 261E formed, in a similar manner to the protective sheet 231, on its one surface opposite to the surface in contact with the main body 51 so as to improve the operability of the display system 1 and improve the appearance of the input/output panel 16.

By forming a pattern or a character by partially recessing or raising the surface of the protective sheet, it possible to indicate various kinds of information and/or improve the visible appearance of the input/output panel 16.

The protective sheet may be formed such that it can be removably attached to the main body 51. This makes it possible to exchange the protective sheet depending on the type of the application used on the display system 1, i.e., depending on the type, the shape, the location, etc., of the user interface displayed on the display screen 51A. This allows a further improvement in operability.

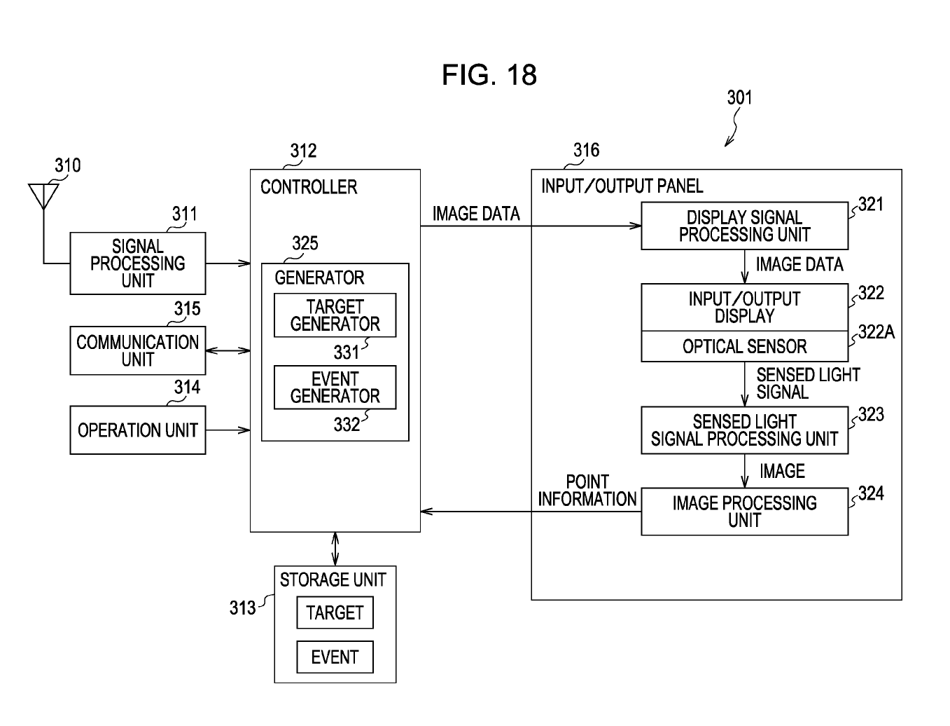

FIG. 18 is a block diagram illustrating a display system according to another embodiment of the present invention.

In the display system 301 shown in FIG. 18, the generator 25 of the input/output panel 16 is moved into the controller 12.

In the display system 301 shown in FIG. 18, an antenna 310, a signal processing unit 311, a storage unit 313, an operation unit 314, a communication unit 315, a display signal processing unit 321, an input/output display 322, an optical sensor 322A, a sensed light signal processing unit 323, an image processing unit 324, and a generator 325 are similar to the antenna 10, the signal processing unit 11, the storage unit 13, the operation unit 14, the communication unit 15, the display signal processing unit 21, the input/output display 22, the optical sensor 22A, the sensed light signal processing unit 23, the image processing unit 24, and the generator 25 in the display system 1 shown in FIG. 1, and thus the display system 301 is capable of performing the displaying/sensing operation in a similar manner to the display system 1 shown in FIG. 1. Note that in the display system 301, a storage unit 313 is used instead of the storage unit 33 disposed in the generator 25 in the display system 1 shown in FIG. 1.

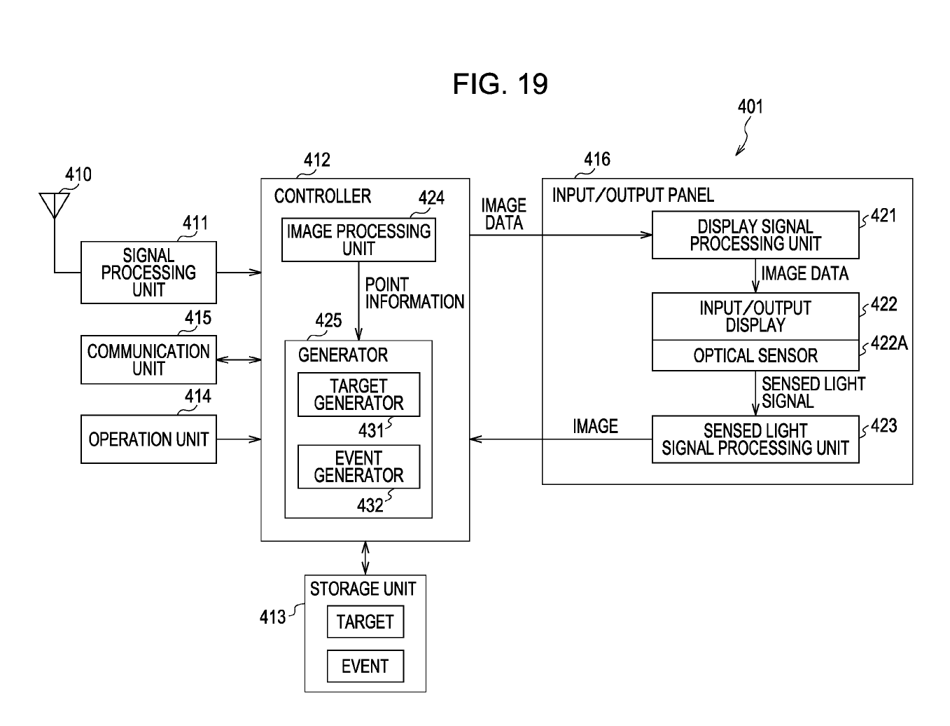

FIG. 19 is a block diagram illustrating a display system according to another embodiment of the present invention.

In the display system 401 shown in FIG. 19, the generator 25 and the image processing unit 24 are moved from the input/output panel 16 into the controller 12 shown in FIG. 1.

In the display system 401 shown in FIG. 19, an antenna 410, a signal processing unit 411, a storage unit 413, an operation unit 414, a communication unit 415, a display signal processing unit 421, an input/output display 422, an optical sensor 422A, a sensed light signal processing unit 423, an image processing unit 424, and a generator 425 are similar to the antenna 10, the signal processing unit 11, the storage unit 13, the operation unit 14, the communication unit 15, the display signal processing unit 21, the input/output display 22, the optical sensor 22A, the sensed light signal processing unit 23, the image processing unit 24, and the generator 25 in the display system 1 shown in FIG. 1, and thus the display system 401 is capable of performing the displaying/sensing operation in a similar manner to the display system 1 shown in FIG. 1.

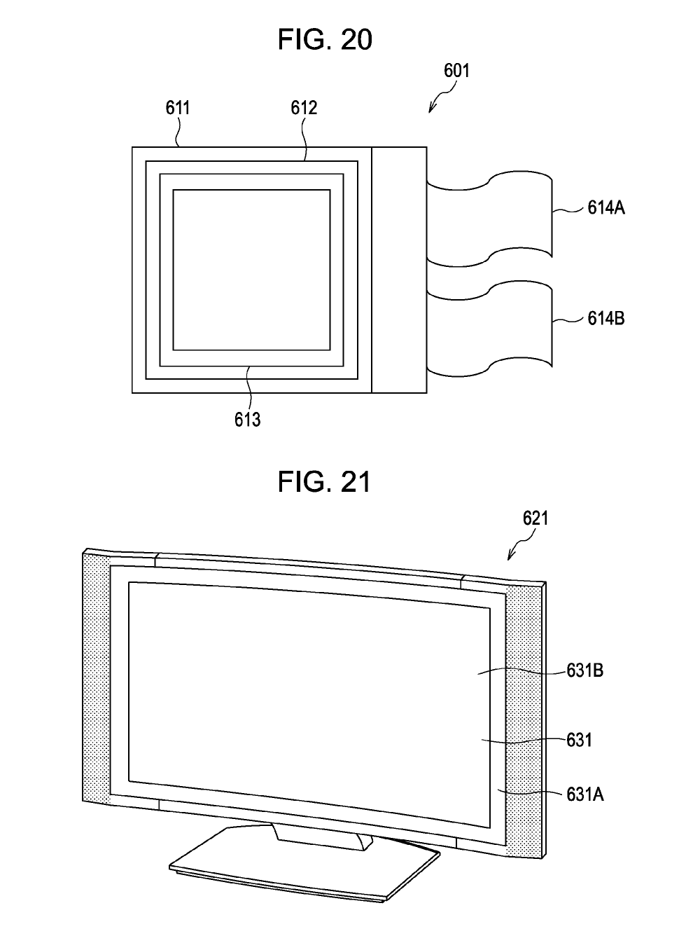

FIG. 20 illustrates an external appearance of an input/output panel 601 according to an embodiment of the present invention. As shown in FIG. 20, the input/output panel 601 is formed in the shape of a flat module. More specifically, the input/output panel 601 is configured such that a pixel array unit 613 including pixels arranged in the form of an array is formed on an insulating substrate 611. Each of pixel includes a liquid crystal element, a thin film transistor, a thin film capacitor, and an optical sensor. An adhesive is applied to a peripheral area around the pixel array unit 613, and an opposite substrate 612 made of glass or the like is bonded to the substrate 611. The input/output panel 601 has connectors 614A and 614B for inputting/outputting a signal to the pixel array unit 613 from the outside. The connectors 614A and 614B may be realized, for example, in the form of a FPC (flexible printed circuit).

An input/output panel may be formed, for example, in the shape of a flat panel in accordance with any one of the embodiments of the invention, and may be used in a wide variety of electronic devices such as a digital camera, a notebook type personal computer, a portable telephone device, or a video camera such that a video signal generated in the electronic device is displayed on the input/output panel. Some specific examples of electronic devices having an input/output panel according to an embodiment of the invention are described below.

FIG. 21 illustrates an example of a television receiver according to an embodiment of the present invention. As shown in FIG. 21, the television receiver 621 has an image display 631 including a front panel 631A and filter glass 631B. The image display 631 may be realized using an input/output panel according to an embodiment of the present invention.

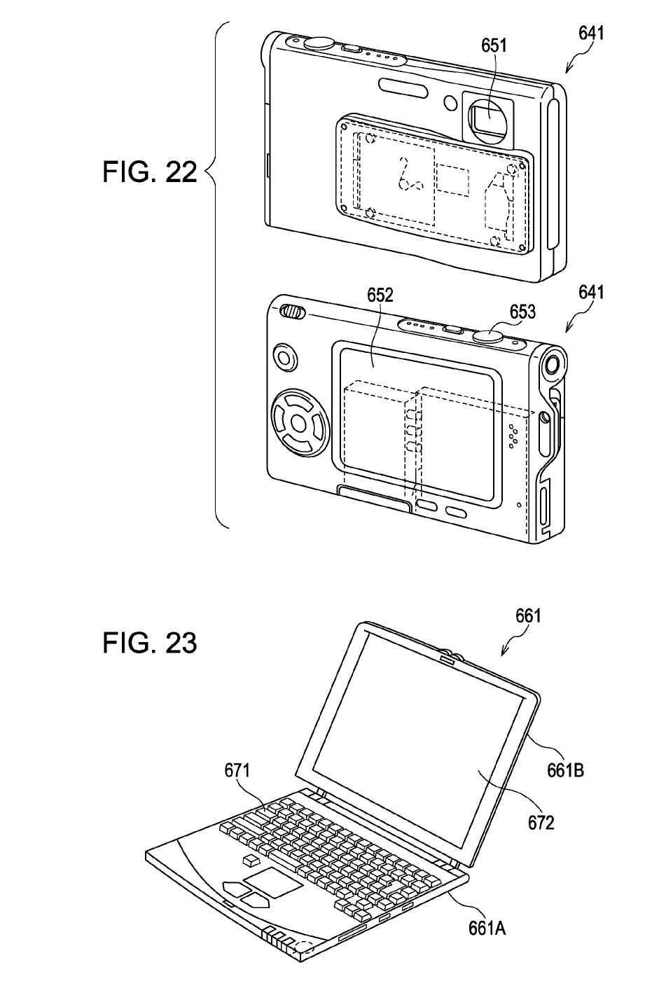

FIG. 22 illustrates a digital camera according to an embodiment of the present invention. A front view thereof is shown on the top of FIG. 22, and a rear view thereof is shown on the bottom of FIG. 22. As shown in FIG. 22, the digital camera 641 includes an imaging lens, a flash lump 651, a display 652, a control switch, a menu switch, and a shutter button 653. The display 652 may be realized using an input/output panel according to an embodiment of the present invention.

FIG. 23 illustrates a notebook-type personal computer according to an embodiment of the present invention. In the example shown in FIG. 23, the personal computer 661 includes a main part 661A and a cover part 661B. The main part 661A includes a keyboard 671 including alphanumeric keys and other keys used to input data or commands. The cover part 661B includes a display 672 adapted to display an image. The display 672 may be realized using an input/output panel according to an embodiment of the present invention.

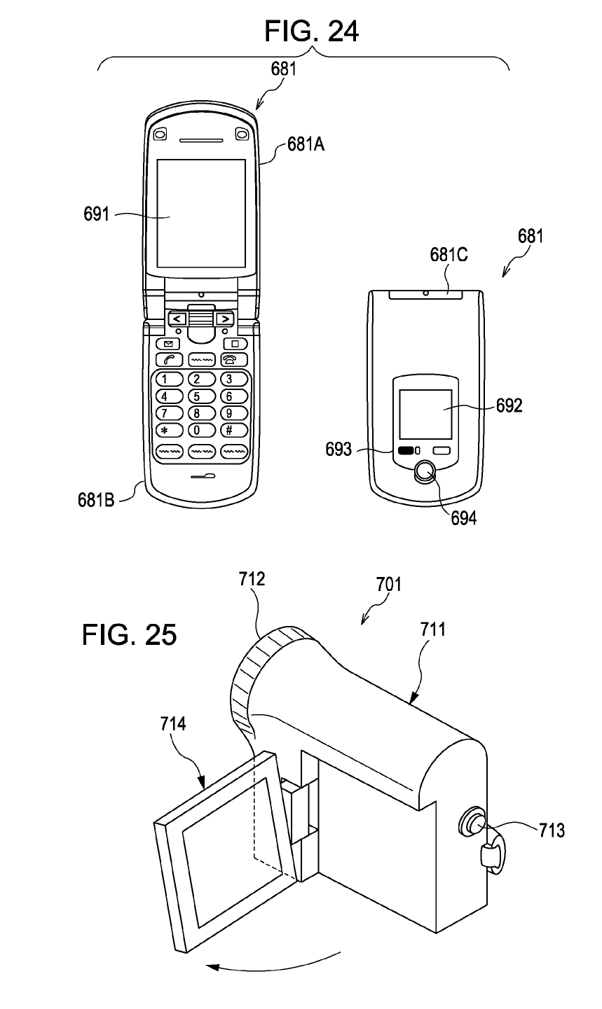

FIG. 24 illustrates a portable terminal apparatus according to an embodiment of the present invention. The portable terminal apparatus in an opened state is shown on the left-hand side of FIG. 24, and the apparatus in a closed state is shown on the right-hand side. As shown in FIG. 24, the portable terminal apparatus 681 includes an upper case 681A, a lower case 681B connected to the upper case 681 via a hinge 681, a display 691, a sub-display 692, a picture light 693, and a camera 694. The display 691 and/or the sub-display 692 may be realized using an input/output panel according to an embodiment of the present invention.

FIG. 25 illustrates a video camera according to an embodiment of the present invention. As shown in FIG. 25, the video camera 701 includes a main bony 711, an imaging lens 712 disposed on a front side, an operation start/stop switch 713, and a monitor 714. The monitor 714 may be realized using an input/output panel according to an embodiment of the invention.

The sequence of processing steps described above may be performed by means of hardware or software. When the processing sequence is executed by software, the software in the form of a program may be installed from a program storage medium onto a computer which is provided as dedicated hardware or may be installed onto a general-purpose computer capable of performing various processes in accordance with various programs installed thereon.

In the present description, the steps described in the program stored in the storage medium may be performed either in time sequence in accordance with the order described in the program or in a parallel or separate fashion.

In the present description, the term “system” is used to describe the entirety of an apparatus including a plurality of sub-apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus including an input/output unit adapted to display an image and sense light incident thereon from the outside, the input/output unit being adapted to accept simultaneous inputting to a plurality of points on a display screen of the input/output unit, the display screen being covered with a transparent or translucent protective sheet.

2. The display apparatus according to claim 1, wherein the surface of the protective sheet is partially recessed or raised in a particular shape.

3. The display apparatus according to claim 2, wherein the surface of the protective sheet is partially recessed or raised in a particular shape corresponding to a user interface displayed on the display screen.

4. The display apparatus according to claim 1, wherein the protective sheet is colored.
